(19) United States
(12) Patent Application Publication
(10) Pub. No.: US 2007/0091106 A1
(43) Pub. Date: Apr. 26, 2007

(54) Adaptive lexical classification system

(76) Inventor: Nathan M. Moroney, Palo Alto, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/259,597

(22) Filed: Oct. 25, 2005

(51) Int. Cl. G09G 5/00

(52) U.S. Cl. 345/581

(57) ABSTRACT

A method for assigning a lexical classifier to characterize a visual attribute corresponding to an image element forming part of an image. The method involves capturing an initial attribute value for the image element and transforming the captured initial attribute value to a lexical classifier. Transformation involves reference to a database including a set of lexical classifiers corresponding to a particular type of visual attribute. The lexical classifier assigned to the visual attribute is recorded for display or further processing. Transformation of the initial attribute value to the lexical classifier involves application of a machine learning algorithm to the database.

### FIELD OF THE PRESENT INVENTION

The present invention relates generally to the naming of visual attributes such as color, shape and texture, and more particularly to an adaptive lexical classification system.

### BACKGROUND OF THE PRESENT INVENTION

Color is a visual attribute resulting from a psychological and physiological response to light waves of a specific frequency impinging upon the eye. The perception of color results from the combined output of three sets of retinal cones having peak sensitivities in the red, green and blue portions of the electromagnetic spectrum. Different levels of stimulus to each set of retinal cones gives rise to the ability to perceive a large range of colors.

Conventional approaches to naming and describing colors have included systems based on color encodings which represent components of a color in terms of a position or coordinates in a usually three dimensional color space. An abridged list of such color'encodings includes RGB, SWOP, CYMK, XYZ and CIELAB.

Different color encodings are suited to different applications. For instance, the RGB color model is composed of the primary colors red, green, and blue which are considered to comprise the “additive primaries” since they can be combined together to produce various other desired colors. The RGB color model uses a rectangular coordinate system with a coordinate axis assigned to each of three color components, red, green, and blue. The RGB system is used in most color CRT monitors and color raster graphics.

The CMYK color model is used primarily for printing and stands for cyan, magenta, yellow and black. The CMYK colors are called the “subtractive primaries” since a desired color is obtained by removing one or more of the subtractive primaries from white light.

Whilst the various color encodings have their uses, they do not provide an intuitive means by which the color name for an image element of an image can be determined, e.g. pixel x,y is “brown”.

Research into color naming has tended to focus on cross- linguistic universal tendencies in the naming of colors. Much of this research is based on the findings of Berlin and Kay (1991), who found universal patterns in application of the eleven basic color names of red, green, yellow, blue, brown, pink, orange, purple, white, gray and black in color naming data collected from various languages. However, these findings do not assist in providing a robust, universal system for communicating color.

It would be desirable to provide a natural and intuitive means for communicating visual attributes such as color which can be universally applied.

### SUMMARY OF THE PRESENT INVENTIONS

Briefly, the present invention provides a method for assigning a lexical classifier to characterize a visual attribute corresponding to an image element forming part of an image. The method involves capturing an initial attribute value for the image element and transforming the captured initial attribute value to a lexical classifier. Transformation involves reference to a database including a set of lexical classifiers corresponding to a particular type of visual attribute. The lexical classifier assigned to the visual attribute is recorded for display and/or further processing. Transformation of the initial attribute value to the lexical classifier involves application of a machine learning algorithm to the database.

### BRIEF DESCRIPTION OF THE DRAWINGS

FIG. 1 is a flow chart showing a method for assigning a lexical classifier to characterize a visual attribute corresponding to an image element according to an embodiment of the invention.

FIG. 2 is a schematic diagram showing the system components according to an embodiment of the invention.

FIG. 3A is a flow chart showing a more detailed implementation of an embodiment of the present invention using nearest neighbour assignment.

FIG. 3B is a flow chart showing a more detailed implementation of an embodiment of the present invention using fuzzy logic.

### DETAILED DESCRIPTION OF THE EMBODIMENTS OF THE PRESENT INVENTION

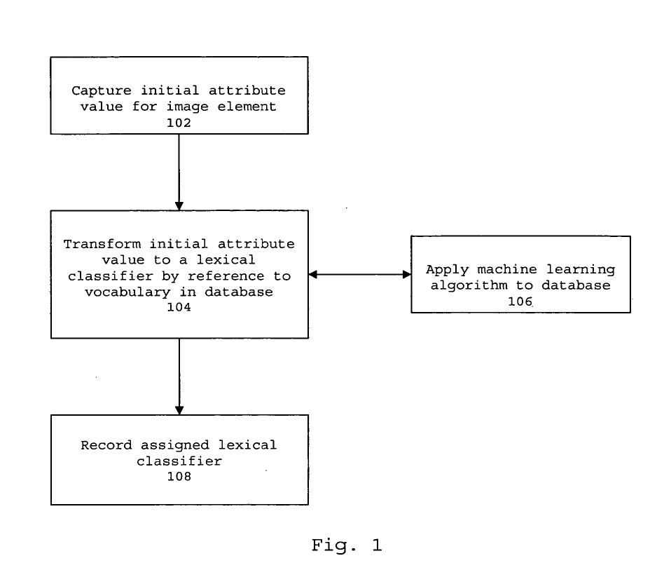

An embodiment of the invention is illustrated in FIG. 1. The method assigns a lexical classifier for characterizing a visual attribute corresponding to an image element forming part of an image. The image element may comprise a pixel when the image is a raster image, or a vector element when the image is a vector image. Although the method is described with reference to color as the visual attribute, it is to be understood that the method has equal utility in assigning lexical classifiers to other visual attributes including texture and shape.

A first step 102 involves capturing an initial attribute value for an image element 102. The initial value may be captured in the form of a conventional color encoding such as an RGB pixel value, an XYZ measurement or a CIELAB encoding. A next step 104 involves transforming the initial attribute value into a lexical classifier by reference to a set or vocabulary of lexical classifiers or color names which are stored in a database. Step 106 involves the application of a machine learning algorithm to the database. Finally, step 108 involves recording the lexical classifier assigned to the image element for further processing and/or display.

The set of lexical classifiers stored in the database is created by collecting a range of color names provided by a large number of participants in response to a visual stimulus. For instance, an extensive vocabulary of color names can be collected from a large number of participants using a communications network such as the Internet. Color samples are displayed to a participant via a browser and the participant is asked to submit the most appropriate color name for that particular sample. This methodology results in the creation of a large database of color names which enables the resulting assigned lexical classifiers to mimic the intuitive and natural use of language.

Machine learning or statistical pattern recognition algorithms are used to determine patterns within a data set and define relationships between the captured initial attribute values and lexical classifiers. Some examples of types of machine learning algorithms which are suitable for application in the context of the present embodiments include nearest neighbor assignment, fuzzy logic and simple classical logic (if, then, else). The choice of specific color naming algorithms is based on various considerations including processing speed, memory requirements, training data format, ease of use, available parameters and the like.

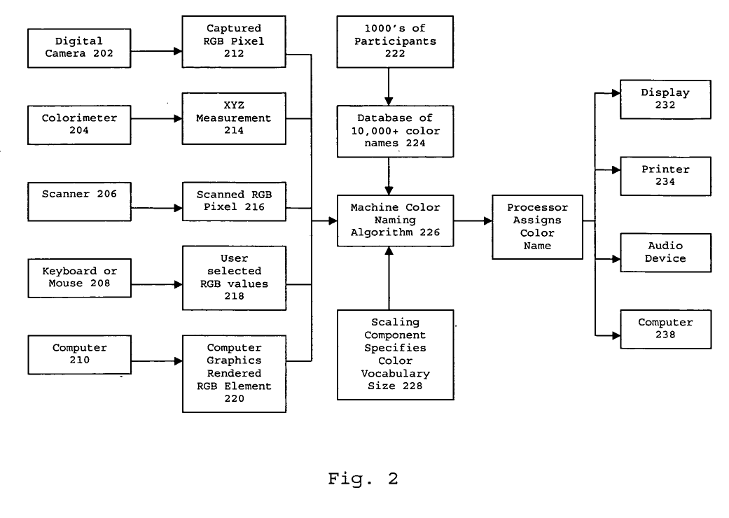

Another embodiment of the invention is illustrated in FIG. 2. A system for assigning a lexical classifier to characterize a visual attribute corresponding to an image element forming part of an image includes an input device for capturing an initial attribute value for the pixel or vector element. The initial attribute value may be captured for example, by a digital camera 202 in the form of an RGB pixel value 212, a calorimeter 204 in the form of an XYZ measurement 214, a scanner 206 in the form of a scanned RGB pixel value 216, a keyboard or mouse 208 in the form of user selected RGB vales 218, or a computer 210 in the form of computer graphics rendered RGB elements 220.

The system includes a database 224 providing a set of lexical classifiers corresponding to a particular type of visual attribute (in this case color). As described above, this set of lexical classifiers is developed by collecting color names from a large number of participants 222. The larger the number of participants and the larger the number of color names collected, the more robust the resulting database of lexical classifiers will be.

The color naming system may be scaled to assign lexical classifiers from a large number of names or a small number of names, depending on the intended application. A database of sufficient size is required to permit such scalability. A scaling component 228 is used to specify a subset of the set of lexical classifiers from which lexical classifiers may be assigned for a given application. The scaling component 228 may operate algorithmically, that is, by adding the names in terms of relative frequency of use or by using less commonly used names later. For instance, the number of color names may be set at eleven to limit the range of lexical classifiers which can be assigned to the eleven most commonly used basic color names of red, green, yellow, blue, brown, pink, orange, purple, white, gray and black. The scaling component 228 may also operate in accordance with user specified directions, if for example the user wants to add a new name, say “peach”.

A processor 230 applies the machine learning algorithm 226 to the database 224 to transform the initial attribute value to a corresponding lexical classifier, i.e. the assigned color name. Finally, an output device in the form of a display 232, printer 234 or audio device 236 displays or reproduces the assigned lexical classifier or otherwise communicates it (i.e. via computer 238) for further application and/or processing.

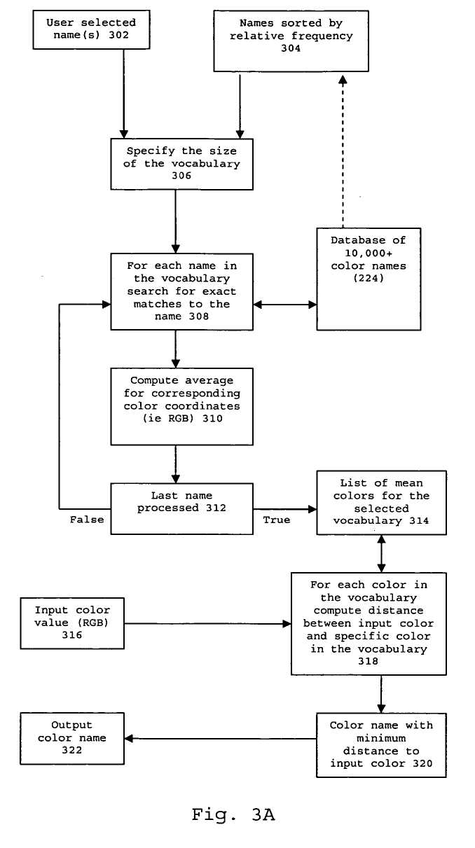

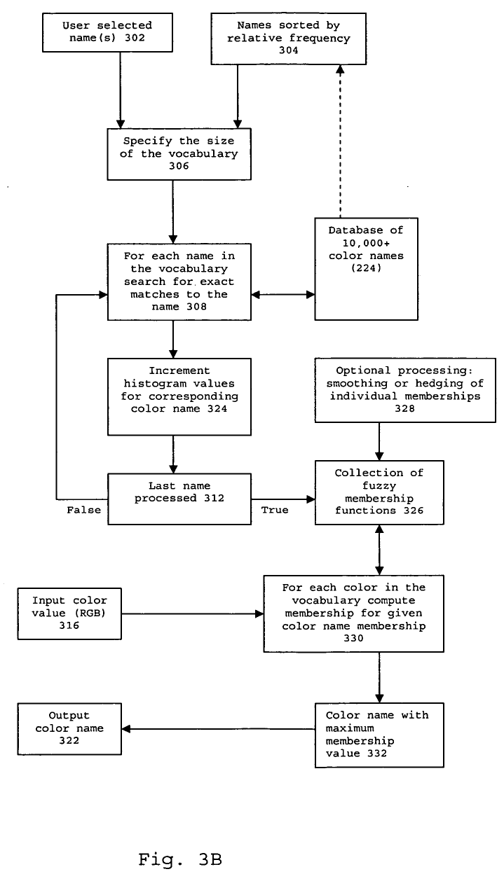

The implementation of the method for assigning a color name is illustrated in more detail in FIG. 3A in accordance with an embodiment using nearest neighbour assignment. The initial step 306 of specifying the size of the color name vocabulary, involves either the user selecting the color names 302, or the size of the vocabulary being determined algorithmically 304. In the illustrated embodiment, algorithmic determination of vocabulary size is based on the relative frequency of use of each color name. That is, the most commonly occurring color names in the database (224) of color names created as previously described form the vocabulary.

A next step 308 involves the system searching the database (224) for an exact match to each of the names in the vocabulary. When an exact match for the color name is located, step 310 involves computing an average color value for the corresponding color coordinates (e.g. RGB coordinates if the input color values are in the RGB color space). Steps 308, 310 are repeated until each color name specified in the vocabulary has been processed 312. The next step 314 involves producing a list of mean color values in an encoding corresponding to the input color values, wherein each mean color value corresponds to one of the color names in the selected vocabulary.

A next step 316 involves an input device capturing the initial input color values. In step 318, the distance between the initial input color value and the mean color values corresponding to each of the color names in the vocabulary is computed. A next step 320 involves assigning the color name having the minimum distance to the initial input color value for the image element. The assigned color name is then recorded for further processing and/or display 322.

FIG. 3B illustrates an alternative embodiment, wherein the method for assigning a color name uses fuzzy logic. The initial steps for setting the size of the color name vocabulary and searching the color name database (224) for an exact match to the color name are as described for steps 302 to 308 in FIG. 3A. Once a match to the color name 308 has been located in the database (224), the next step 324 involves the system computing an increment histogram value for each of the color names. Steps 308 and 324 are repeated until each name in the vocabulary has been processed 312. Step 326 involves grouping of the histogram values into fuzzy membership functions.

Given a complete set of fuzzy membership functions additional, optional processing may be applied in a next step 328. For example a smoothing algorithm may be applied if the data is noisy due to limited number of data points or participant uncertainty. Alternatively, the membership may be “hedged” to expand or contract the range for a specific color name. “Hedging” may be required in cases where the range of colors assigned to a specific color name, such as “brown” needs to be increased.

In step 316 an input device captures the initial input color values as described for FIG. 3A above. Step 330 involves computing a membership for each color name in the color vocabulary. The next step 332 involves assigning the color name with the maximum membership value to the input color value. The assigned color name is recorded for further processing and/or display in a final step 322.

It is an advantage of the above described embodiments that lexical classifiers are assigned to attributes from a large and diverse database that allows the system to be both robust and scaleable. The system is not based on arbitrary hierarchical modifiers or fixed nomenclature, but rather embodies actual patterns of natural language with respect to color naming. The resulting color names are therefore generally a far more intuitive representation than the original color encoding which is transformed by the system.

It should be understood that the adaptive lexical classification system whilst described largely in the context of color naming, has equal applicability to classification of other attributes unrelated to color, such as shape and texture for example. For instance, if the attribute type of interest were shape, a set of lexical classifiers could be developed to create a large scale database to be used in conjunction with a machine learning algorithm to assign lexical classifiers such as “round” or “diamond”.

Although the present invention has been described in terms of the presently preferred embodiment, it is to be understood that the disclosure is not to be interpreted as limiting. Various alterations and modifications will no doubt become apparent to those skilled in the art after having read the above disclosure. Accordingly, it is intended that the appended claims be interpreted as covering all alterations and modifications as fall within the true spirit and scope of the invention.

1. A method for assigning a lexical classifier to characterize a visual attribute corresponding to an image element forming part of an image, the method comprising the following steps:
capturing an initial attribute value for the image element;
transforming the initial attribute value to a lexical classifier by reference to a database including a set of lexical classifiers corresponding to a particular type of visual attribute; and
recording the lexical classifier assigned to the visual attribute;
wherein transformation of the initial attribute value to the lexical classifier involves application of a machine learning algorithm to the database.

2. A method according to claim 1, wherein the image is a raster image and the image element is a pixel.

3. A method according to claim 1, wherein the image is a vector image and the image element is a vector element.

4. A method according to claim 1, wherein the method is preceded by the following step:
specifying a subset of the set of lexical classifiers within the database from which the lexical classifier may be assigned.

5. A method according to claim 1, wherein the types of visual attributes for which lexical classifiers may be assigned comprise:
color;
shape; and
texture.

6. A method according to claim 1, wherein the set of lexical classifiers is developed by collecting the lexical classifiers corresponding to a particular type of visual attribute from a large number of participants in accordance with the natural language usage of those participants.

7. A system for assigning a lexical classifier to characterize a visual attribute corresponding to an image element forming part of an image, the system comprising:
an input device for capturing an initial attribute value for the image element;
a database providing a set of lexical classifiers corresponding to a particular type of visual attribute;
a processor for applying a machine learning algorithm to transform the initial attribute value to a lexical classifier; and
an output device for communicating the lexical classifier for subsequent applications.

8. A system according to claim 7, wherein the image is a raster image and the image element is a pixel.

9. A system according to claim 7, wherein the image is a vector image and the image element is a vector element.

10. A system according to claim 7, further including a scaling component for specifying a subset of the set of lexical classifiers within the database from which the lexical classifier may be assigned.

11. A system according to claim 7, wherein the types of visual attributes for which lexical classifiers may be assigned comprise:
color;
shape; and
texture.

12. A system according to claim 7, wherein the set of lexical classifiers is developed by collecting the lexical classifiers corresponding to a particular type of visual attribute from a large number of participants in accordance with the natural language usage of those participants.

13. Computer-readable media having programmed thereon computer software for assigning a lexical classifier to characterize a visual attribute corresponding to an image element forming part of an image, the computer software adapted to perform the following steps:
capturing an initial attribute value for the image element;
transforming the initial attribute value to a lexical classifier by reference to a database including a set of lexical classifiers corresponding to a particular type of visual attribute; and
recording the lexical classifier assigned to the visual attribute;
wherein transformation of the initial attribute value to the lexical classifier involves application of a machine learning algorithm to the database.

14. Computer readable media according to claim 13, wherein the image is a raster image and the image element is a pixel.

15. Computer readable media according to claim 13, wherein the image is a vector image and the image element is a vector element.

16. Computer-readable media according to claim 13, wherein the computer software is further adapted to perform the following step:
specifying a subset of the set of lexical classifiers within the database from which the lexical classifier may be assigned.

17. Computer-readable media according to claim 13, wherein the types of visual attributes for which lexical classifiers may be assigned comprise:
color;
shape; and
texture.

18. Computer-readable media according to claim 13, wherein the set of lexical classifiers is developed by collecting the lexical classifiers corresponding to a particular type of visual attribute from a large number of participants in accordance with the natural language usage of those participants.
